(19) United States
(12) Patent Application Publication
(10) Pub. No.: US 2003/0011168 A1
(43) Pub. Date: Jan. 16, 2003

(54) Hitch accessory

(76) Inventor: Ulle Svensson, Visby (SE)

Correspondence Address: Rolf Fasth, Fasth Law Office, 189 Curtis Drive, Longview, WA, 98632-5374, US

(21) Appl. No.: 10/203,051

(22) PCT Filed: Feb. 1, 2001
(86) PCT No.: PCT/SE01/00200

(51) Int. Cl. B60D 1/00

(52) U.S. Cl. 280/477

(57) ABSTRACT

The trailer hitch accessory is used for guiding a trailer hitch to a ball joint. The hitch accessory has a hollow housing (25) with a front end (40) with angled sidewalls (30a, 30b). A cord (24) is attached to the axle (48) and extends through the front end (40). A U-shaped lock mechanism (31) is attached to the housing (25) and has opposite sidewalls (52,54). The sidewalls each has a groove (58, 72) defined therein. The lock mechanism (31) is adapted to receive the trailer hitch (12) but not an outwardly protruding bolt (13). The trailer hitch (12) is positionable inside the U-shaped lock mechanism (31) only when outer ends of the bolt (13) are disposed in the grooves (68, 78) defined in the sidewalls. A locking plate (64, 80) slidably attached to the sidewalls (52, 54) to lock the outer ends (15) of the bolt.

### TECHNICAL FIELD

The present invention relates to a hitch accessory that is attached to a conventional trailer hitch to facilitate the accurate positioning of the trailer hitch above the ball socket of a vehicle.

### BACKGROUND AND SUMMARY OF THE INVENTION

Most drivers find it difficult to back up a vehicle towards a trailer so that the ball joint is positioned adjacent to and below the trailer hitch of a trailer. If the vehicle is stopped too far away from the trailer hitch, the trailer hitch is often very heavy to manually move towards the ball joint of the vehicle. Similarly, it can be very expensive to repair damages from backing up the vehicle too close to the trailer hitch and the trailer hitch makes an undesirable indentation in the back end of the vehicle.

There is a need for a simple and safe way to connect a trailer to a vehicle without having to move the trailer manually and without causing any damage to the vehicle. There is also a need to conveniently attach, without requiring any complicated tools, a guiding hitch accessory to the trailer hitch to properly guide the ball joint and trailer hitch towards one another since most trailer hitch assemblies are not equipped with any guiding means.

The trailer hitch accessory of the present invention may be used for guiding a trailer-hitch to a ball joint. The hitch accessory has a hollow housing with an axle extending therethrough. The housing has a front end with angled sidewalls to form a V-shape. A cord is attached to the axle and extends through the front end. A U-shaped lock mechanism is attached to an upper edge of the housing. The lock mechanism has opposite sidewalls that extend away from the housing. Each sidewall has a groove defined therein and the U-shaped lock mechanism is adapted to receive a trailer hitch but not the outwardly protruding side bolts. The trailer hitch may be positioned inside the U-shaped lock mechanism only when the side bolts are disposed in the grooves defined in the sidewalls. It is to be understood that the lock mechanism may be used even if the trailer hitch does not have an protruding side bolts. In this way, the lock mechanism may be used to lock another component of the trailer hitch to the U-shaped lock mechanism.

A locking plate is slidably attached to the sidewalls of the locking mechanism and is movable between a first closed position, to extend across the groove to F close a portion of the groove and secure the bolts, or any other components of the trailer hitch, within the grooves of the sidewalls, and a second open position, to open the groove and release the bolts of the trailer hitch from the groove.

### BRIEF DESCRIPTION OF THE DRAWINGS

FIG. 1 is a perspective view of the hitch accessory of the present invention and a rope hooked around a ball socket;

FIG. 2 is a detailed perspective view of a housing of the hitch accessory of the present invention;

FIG. 3 is a detailed perspective view of the housing of the hitch accessory;

FIG. 4 is a top view of the housing of the hitch accessory;

FIG. 5 is a detailed perspective rear view of the housing of the hitch accessory; and

FIG. 6 is a detailed perspective view of the housing of the hitch accessory attached to the lock mechanism.

### DETAILED DESCRIPTION

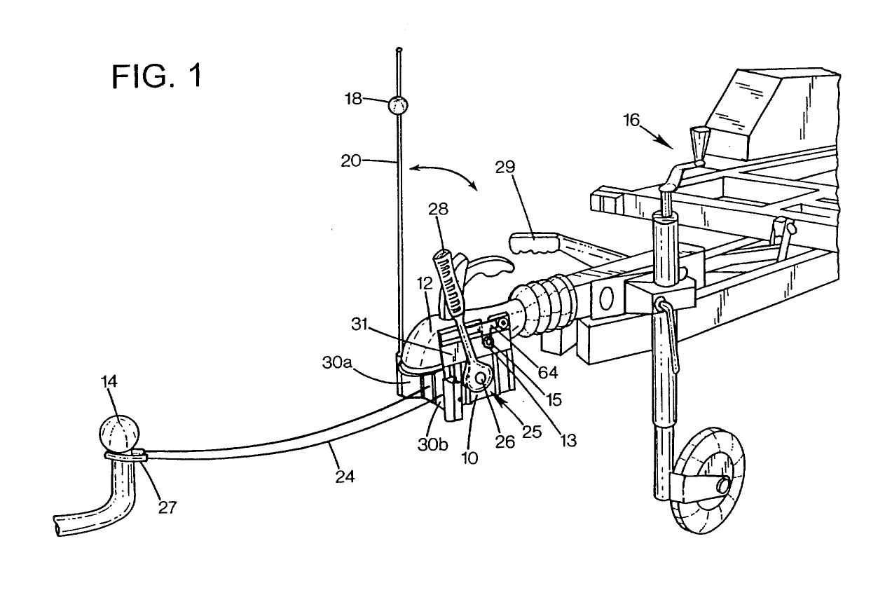

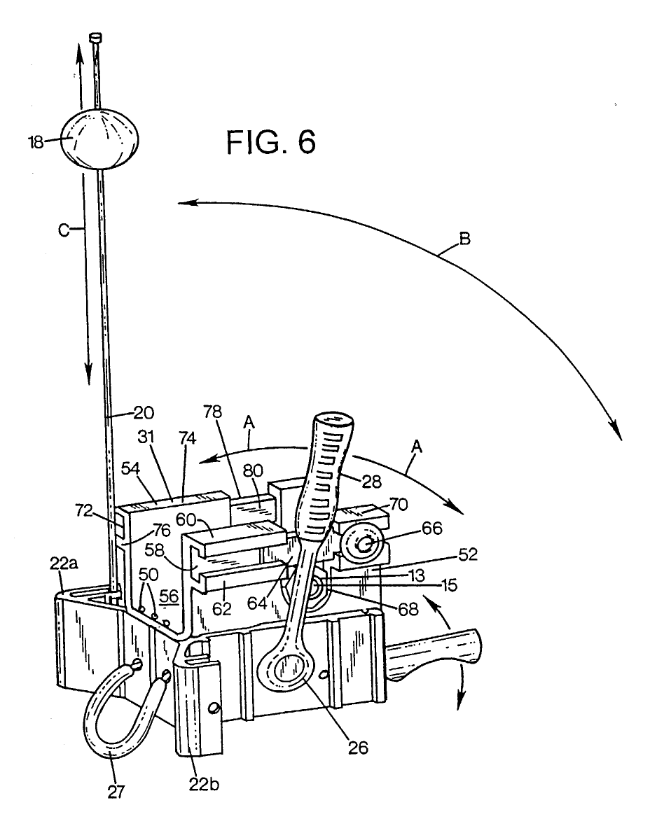

With reference to FIGS. 1-4, the hitch accessory 10 of the present invention is located below a conventional trailer hitch 12. The hitch accessory 10 makes it easier to position and connect a ball joint 14 of a vehicle below a conventional trailer hitch 12 that has an outwardly protruding bolt 13 with outer ends 15 that extend in a sideways direction. Only one outer end 15 is shown in FIGS. 1 and 6 and the opposite end of the bolt 13 also extends beyond the sidewall of the trailer hitch 12 the same way as the outer end 15.

It is often difficult to back up a vehicle and position the ball joint 14 right below the trailer hitch 12 of a trailer 16. The present invention only requires the driver to position the vehicle somewhat close to the trailer hitch 12 by first being guided by a white ball/marker 18 that is attached to a vertical pole 20. The pole 20 may be supported by one of the holders 22a, 22b that has an opening defined therein for receiving the pole 20. The pole may be placed on the right or left side of the hitch 12.

The driver of the vehicle may look in the rear mirror and back up the vehicle so that the back end of the vehicle is somewhat close to the marker 18. The marker 18 may be raised or lowered, as desired, so that the driver clearly sees the marker in the rear mirror.

When the ball joint 14 is adjacent to the trailer hitch 12 of the trailer 16, such as about 1 meter apart, the marker 18 may either be removed or moved into a transport position so that it is not in the way. A double cord 24 may then be pulled out from a housing 25 of the hitch accessory 10, as best shown in FIG. 1, and placed over the ball joint 14. The cord 24, preferably, has both its ends attached to an axle 48 inside the accessory 10 so that there is not need for attaching a hook on the cord to engage the ball joint 14. The cord 24 should be flexible so that it is easy to place over the ball joint 14 although the ball joint 14 may not be aligned with the hitch 12. The double cord 24 has better guiding properties than a single cord. A mid-section of the cord 24 has a protective sleeve 27 that prevents or reduces wear on the cord 24 itself. The sleeve 27 also has the function of informing the user where to grab when pulling out the cord from the housing 25.

The hitch accessory 10 has a protruding crank mechanism 26 that may be used to pull in the cord 24. The mechanism 26 may protrude on both sides of the accessory 10. Preferably, a crank handle 28 is mounted on the crank mechanism 26 so that by moving the handle 28, the cord 24 is tightened so that a parking brake 29 of the trailer 16 may be released. The mechanism 26 only pulls the cord when moved in one direction. However, the mechanism 26 has a locking mechanism so that the cord 24 remains tightened although the handle 28 is moved in an opposite direction to be in a position to again pull the cord 24 towards the hitch 12. By further winching the handle 28, the trailer 16 is pulled towards the ball joint 14. A front portion of the accessory 10 has two guiding walls 30a, 30b that form an obtuse angle relative to one another or a Y-shaped or V-shaped front so that the ball joint 14 may be guided into a central position by the walls 30 as the hitch 12 is pulled closer to the ball joint 14. The relatively wide guiding walls 30 may also prevent the hitch from passing the ball joint 14 all together and damage the back of the vehicle. When the hitch 12 is positioned above and aligned with the ball joint 14, the hitch 12 is lowered onto the ball joint 14 and fastened thereto. If so desired, the cord 24 may remain around the ball joint 14 for extra safety should the hitch 12 disconnect from the ball joint 14 during transportation.

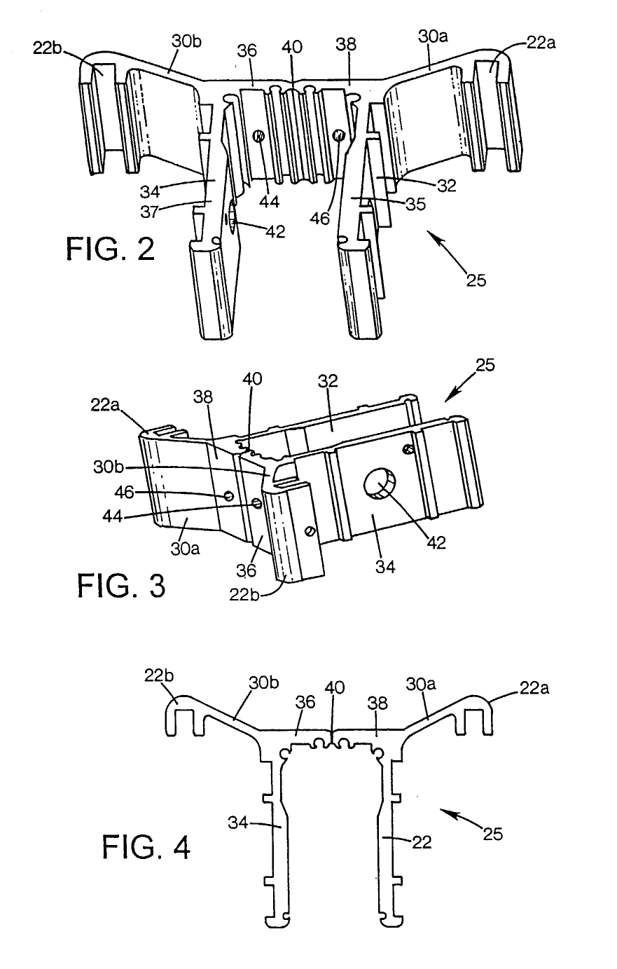

With reference to FIGS. 2-4, the housing 25 has two side walls 32, 34 and front sides 36, 38, respectively, that are attached to one another at a middle part 40. The side wall 34 has an opening 42 defined therein for receiving the mechanism 26. The front sides 36, 38 each defines openings 44, 46, respectively, for receiving the cord 24. The two side pieces are separatable so that if one piece is damaged, it may be replaced with another piece without having to buy a complete unit.

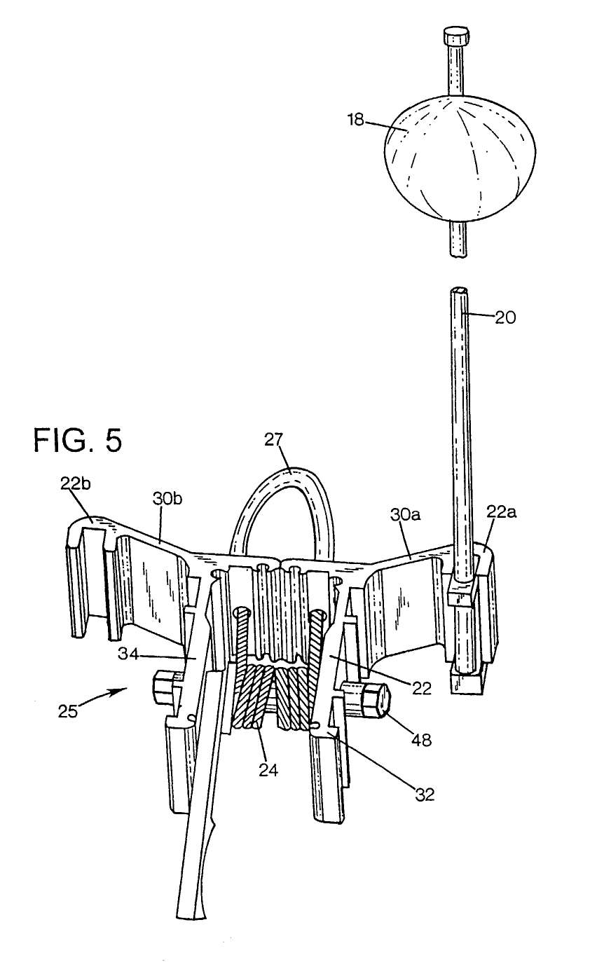

With reference to FIGS. 5-6, the views are very similar to the views in FIGS. 2-3, respectively, except that the cord 24 is rolled up on the horizontal axle 48 that is rotatably attached to the housing and in operative engagement with the crank mechanism 26. In this way, the cord 24 may easily be rolled out by pulling on the segment 27 and rolled in by turning the axle 48 by moving the handle 28 back and forth as shown by the arrows A. FIG. 6 also shows that the ball 18 may be lowered and raised on the rod 20, as shown by arrows C. The rod 20 may also be folded backwardly as shown by the arrows B.

An important feature of the present invention is a lock mechanism 31 that is attached to an upper end of the hitch accessory 10 by bolts 50 or by welding. The mechanism 31 is U-shaped and has vertical sidewalls 52, 54 that are attached to a horizontal bottom wall 56. Preferably, the bottom wall 56 is sufficiently wide to receive the trailer hitch 12 but not the outer ends 15 of the bolt 13. For clarity, the trailer hitch 12 is not shown in FIG. 6 but the outer end 15 of the bolt 13 is illustrated. It is to be understood that the lock mechanism 31 may be designed to receive the trailer hitch 12 and the bolt 13 so that another component of the trailer hitch 12 may be locked to the lock mechanism 31.

In the preferred embodiment, the sidewall 52 has a groove 58 extending along the lock mechanism 31 and defined between elongate protrusions 60, 62 so that a locking plate 64 may be slid sideways along the groove 58. The plate 64 has a relatively flat knob 66 so that the movement of the plate 64 within the groove 58 is not hindered by the handle 28 when the handle 28 is removably attached to the knob 26. The sidewall 52 has a U-shaped groove 68 defined therein. The groove 68 extends from a top portion 70 of the sidewall 52 almost to the bottom wall 56. In this way, the U-shaped groove 68 cuts through the protrusions 60, 62 and the plate 64 may extend across the U-shaped groove 68 and partially cover and upper end of the groove 68.

Similarly, the sidewall 54 has a groove 72 defined between elongate protrusions 74, 76 and has a U-shaped groove 78 defined therein that extends from a top portion of the sidewall 54 almost to the bottom wall 56. A locking plate 80 is movable within the groove 72 so that the plate 80 may extend across the U-shaped groove 78.

In operation, the user may push the lock mechanism 31 upwardly so that the outer ends 15 of the bolt 13 on each side of the trailer hitch 12 are positioned inside the U-shaped grooves 68, 78, as shown in FIG. 1. Of course, other components of the trailer hitch 12 may be used to lock the trailer hitch 12 in place. The locking plate 64 is slid sideways in the groove 58 until locking plate 64 extends across the groove 68 to capture the outer end 15 of the bolt 13, as shown in FIG. 6. Similarly, the locking plate 80 is shifted along the groove 72 until the plate 80 extends across the U-shaped groove 78 to capture the opposite protruding end of the bolt 13. In this way, the lock mechanism 31 and the hitch accessory 10 are attached to the trailer hitch 12 without requiring any tools to mount or remove the hitch accessory 10 from the trailer hitch 12. The hitch accessory may be removed from the trailer hitch 12 by sliding the plates 64, 80 within each respective groove to release both ends of the bolt 13. The hitch accessory may then be lowered and disengaged from the trailer hitch 12.

The lock mechanism 31 of the hitch accessory 10 of the present invention may be attached to an existing towing hitch mechanism or be integral with the trail hitch 12.

While the present invention has been described in accordance with preferred compositions and embodiments, it is to be understood that certain substitutions and alterations may be made thereto without departing from the spirit and scope of the following claims.

I claim:

1. A trailer hitch accessory for guiding a trailer hitch to a ball joint, comprising:
a hollow housing (25) having an axle (48) extending therethrough, the housing (25) having a front end (40) with angled sidewalls (30a, 30b);
a cord (24) attached to the axle (48) and extending through the front end (40);
a U-shaped lock mechanism (31) attached to the housing (25), the lock mechanism (31) having opposite sidewalls (52, 54) extending away from the housing (25), each sidewall (52, 54) having a groove (58, 72) defined therein, the U-shaped lock mechanism (31) being adapted to receive a trailer hitch (12), the trailer hitch (12) being positionable inside the U-shaped lock mechanism (31);
a locking plate (64, 80) slidably attached to the sidewalls (52, 54) of the locking mechanism (31), the locking plate (64, 80) being movable between a first closed position to extend across the groove (68, 78) to close a portion of the groove (68, 78) and secure the trailer hitch (12) to the locking mechanism (31) and a second open position to open the grooves (68, 78) and release the trailer hitch (12) from the lock mechanism (31).

2. The trailer hitch accessory according to claim 1 wherein the lock mechanism (31) prevents the trailer hitch (12) from horizontally sliding along the lock mechanism (31) as long as an outer end (15) of a bolt (13) is disposed inside the groove (68).

3. The trailer hitch accessory according to claim 2 wherein the locking plate (64) prevent vertical movement of the outer end (15) when the locking plate extends across the groove (68) and is positioned inside the handle 28.

4. The trailer hitch accessory according to claim 1 wherein the front end (40) of the housing (25) has openings (44, 46) defined therein for receiving the cord (24).

5. The trailer hitch accessory according to claim 1 wherein the trailer hitch (12) is positionable within the lock mechanism (31) only when the outer end (15) of the bolt (13) is disposed in the grooves (68, 78) defined in the side walls (50, 52).

6. A method of attaching a hitch accessory to a trailer hitch and attaching a ball joint to the trailer hitch, comprising:
(a) placing a lock mechanism (31), attached to a hitch accessory (10), below a trailer hitch (12) and moving the lock mechanism (31) upwardly until a set of grooves (68, 78) engage outwardly protruding outer ends (15) of a bolt (13) on the trailer hitch (12);
(b) shifting a locking plate (64, 80) on the lock mechanism (31) sideways until the locking plate (64, 80) extend across the groove (68, 78);
(c) pulling out a cord (24) from the trailer hitch (12) and engaging the cord (24) to the ball joint (14); and
(d) turning a handle (28) on the trailer hitch (12) to shorten the cord (24) and pulling the trailer hitch (12) towards the ball joint (14).

7. The method according to claim 6 wherein the method further comprises guiding the ball joint (14) to a central front end (40) of the trailer hitch (12) with angled guide members (30a, 30b).

8. The method according to claim 6 wherein step (b) further comprises moving the locking plate (64, 80) along a groove (58, 72) defined on an outside wall of the lock mechanism (31).

9. The method according to claim 6 wherein the method further comprises removing the lock mechanism (31) from the trailer hitch (12) by shifting the lock plate (64, 80) away from the groove (68, 78) and lowering the hitch accessory (10) relative to the trailer hitch (12).

10. The method according to claim 6 wherein the method further comprises removing the handle (28) from the hitch accessory (10).
